(19) United States
(12) Patent Application Publication
(10) Pub. No.: US 2016/0132841 A1
(43) Pub. Date: May 12, 2016

(54) TRANSACTING ACROSS MULTIPLE TRANSACTIONAL DOMAINS

(71) Applicant: NetApp Inc., Sunnyvale, CA (US)

(72) Inventor: Craig Fulmer Everhart, Pittsburgh, PA (US)

(21) Appl. No.: 14/539,052

(22) Filed: Nov. 12, 2014

(51) Int. Cl. G06Q 20/02; G06Q 20/38

(52) U.S. Cl. CPC G06Q 20/027; G06Q 20/3829

(57) ABSTRACT

One or more techniques and/or systems are provided for facilitating transactions across multiple transactional domains. For example, a first committer stores first data according to a first transactional domain (e.g., communication protocol data of a smart television) and a second committer stores second data according to a second transactional domain (e.g., communication protocol data of a mobile device). The first committer may commit to updating the first data from an old data state to a new data state (e.g., update from an unauthenticated protocol to an authenticated protocol). The first committer may instruct the second committer to perform a second commit of the second data to the new data state. If the second commit succeeds, then the first committer may utilize the new data state (e.g., utilize the authenticated protocol for communication) otherwise the first committer may utilize the old data state (e.g., utilize the unauthenticated protocol for communication).

### BACKGROUND

Many transactions may be carried out over multiple transactional domains. For example, a user may be transferring money between a first bank account of a first bank and a second bank account of a second bank. The first bank may utilize a first transactional domain for maintaining and updating the first bank account. The first transactional domain may comprise fields for storing information, commands for updating account information, and/or other proprietary transactional functionality and/or representations of data. The second bank may utilize a second transactional domain for maintaining and updating the second bank account. The second transactional domain may comprise fields for storing information, commands for updating account information, and/or other proprietary transactional functionality and/or representations of data, which may be different than the first transactional domain.

Expensive errors may occur if the first bank and the second bank do not correctly coordinate transactions for updating the first bank account and the second bank account. For example, a debit of the first bank account may successfully commit while a deposit into the second bank account may fail, thus resulting in erroneous financial information for the user if the debited money is not accounted for appropriately. A separate transactional monitor and/or two-phase commit functionality may be used to facilitate the transactions. Unfortunately, expensive hardware and/or overhead (e.g., the first bank and the second bank may incur overhead in creating UNDO logs and REDO logs for all transactions) may be introduced by the transactional monitor and/or the two-phase commit functionality.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of facilitating transactions across multiple transactional domains.

FIG. 4A is a component block diagram illustrating an exemplary system for facilitating transactions across multiple transactional domains.

FIG. 4B is a component block diagram illustrating an exemplary system for facilitating transactions across multiple transactional domains, where a first committer performs a first commit.

FIG. 4C is a component block diagram illustrating an exemplary system for facilitating transactions across multiple transactional domains, where a second committer attempts a second commit.

FIG. 4D is a component block diagram illustrating an exemplary system for facilitating transactions across multiple transactional domains, where a second commit, by a second committer, is successful.

FIG. 4E is a component block diagram illustrating an exemplary system for facilitating transactions across multiple transactional domains, where a second commit, by a second committer, is unsuccessful.

FIG. 5 is a component block diagram illustrating an exemplary system for facilitating transactions across multiple transactional domains, where a message is evaluated to determine that a second commit, by a second committer, was successful.

FIG. 6 is a component block diagram illustrating an exemplary system for facilitating transactions across multiple transactional domains, where a message is evaluated to determine that a second commit, by a second committer, was unsuccessful.

FIG. 7 is a component block diagram illustrating an exemplary system for facilitating transactions across multiple transactional domains, where a message from a second committer is evaluated using one or more read commands.

FIG. 8 is a component block diagram illustrating an exemplary system for facilitating transactions across multiple transactional domains, where an encrypted message is sent to a second committer, and the response indicated that decryption was successful.

FIG. 9 is a component block diagram illustrating an exemplary system for facilitating transactions across multiple transactional domains, where an encrypted message is sent to a second committer, and the response indicates that decryption was unsuccessful.

FIG. 10 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for facilitating transactions across multiple transactional domains are provided. A first committer associated with a first transactional domain and a second committer associated with a second transactional domain may utilize such systems and/or techniques to arrive at either a joint commit or a joint abort when updating data from an old data state to a new data state in a manner that may reduce processing overhead and/or the use of additional hardware for transactional monitoring. In an example, the first committer may perform a first commit from the old data state to the new data state such that the first committer can proceed notwithstanding ambiguity of whether the second committer successfully or unsuccessfully committed to updating from the old data state to the new data state (e.g., upon a determination that the second committer failed to perform the update, the first committer may revert back to the old data state). Transactions may be facilitated for negotiating between communication protocols of two devices (e.g., a smart phone may attempt to wirelessly connect with a speaker system using a wireless protocol such as Bluetooth), negotiating between the use of authentication keys, and/or for updating various types of data.

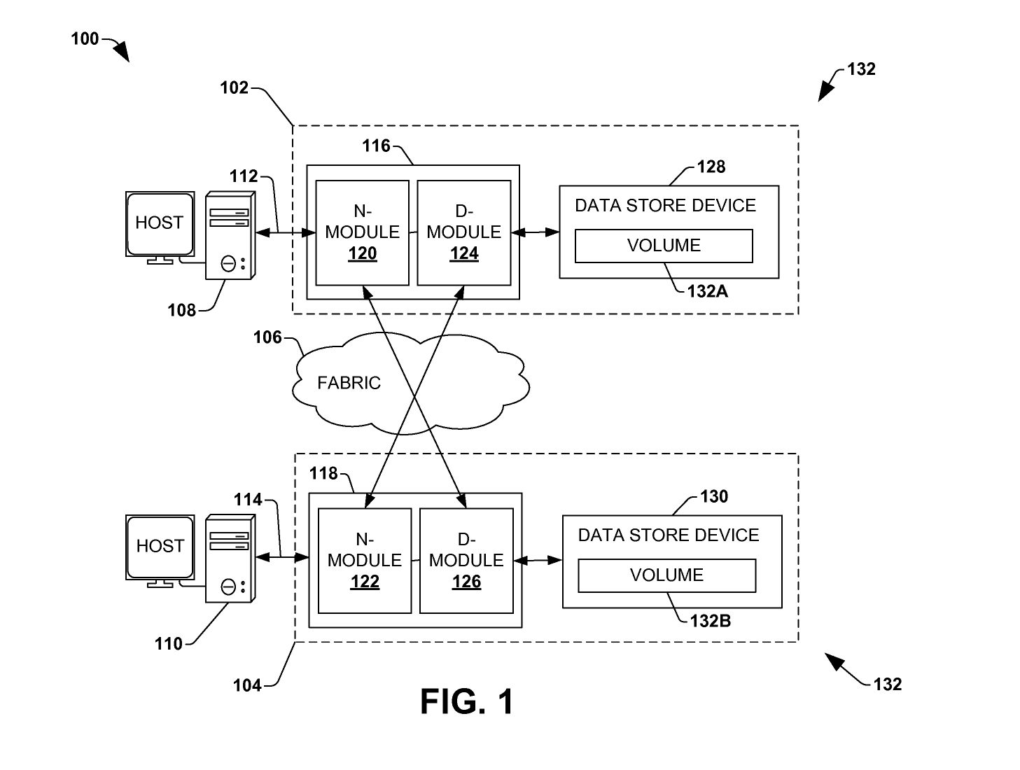

To provide context for facilitating transactions across multiple transactional domains, FIG. 1 illustrates an embodiment of a clustered network environment or a network storage environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems or storage sites 102 and 104 that are coupled over a cluster fabric 106, such as a computing network embodied as a private Infiniband, Fibre Channel (FC), or Ethernet network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 comprise storage controllers (e.g., node 116 may comprise a primary or local storage controller and node 118 may comprise a secondary or remote storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

In an example, a first cluster of nodes such as the nodes 116, 118 (e.g., a first set of storage controllers configured to provide access to a first storage aggregate comprising a first logical grouping of one or more storage devices) may be located on a first storage site. A second cluster of nodes, not illustrated, may be located at a second storage site (e.g., a second set of storage controllers configured to provide access to a second storage aggregate comprising a second logical grouping of one or more storage devices). The first cluster of nodes and the second cluster of nodes may be configured according to a disaster recovery configuration where a surviving cluster of nodes provides switchover access to storage devices of a disaster cluster of nodes in the event a disaster occurs at a disaster storage site comprising the disaster cluster of nodes (e.g., the first cluster of nodes provides client devices with switchover data access to storage devices of the second storage aggregate in the event a disaster occurs at the second storage site).

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that facilitating transactions across multiple transactional domains may be implemented within the clustered network environment 100. For example, a first committer component may be implemented for the node 116 as a first committer associated with a first transactional domain. A second committer component may be implemented for the node 118 as a second committer associated with a second transactional domain. The first committer component and/or the second committer component may facilitate transactions between the first transactional domain and the second transactional domain.

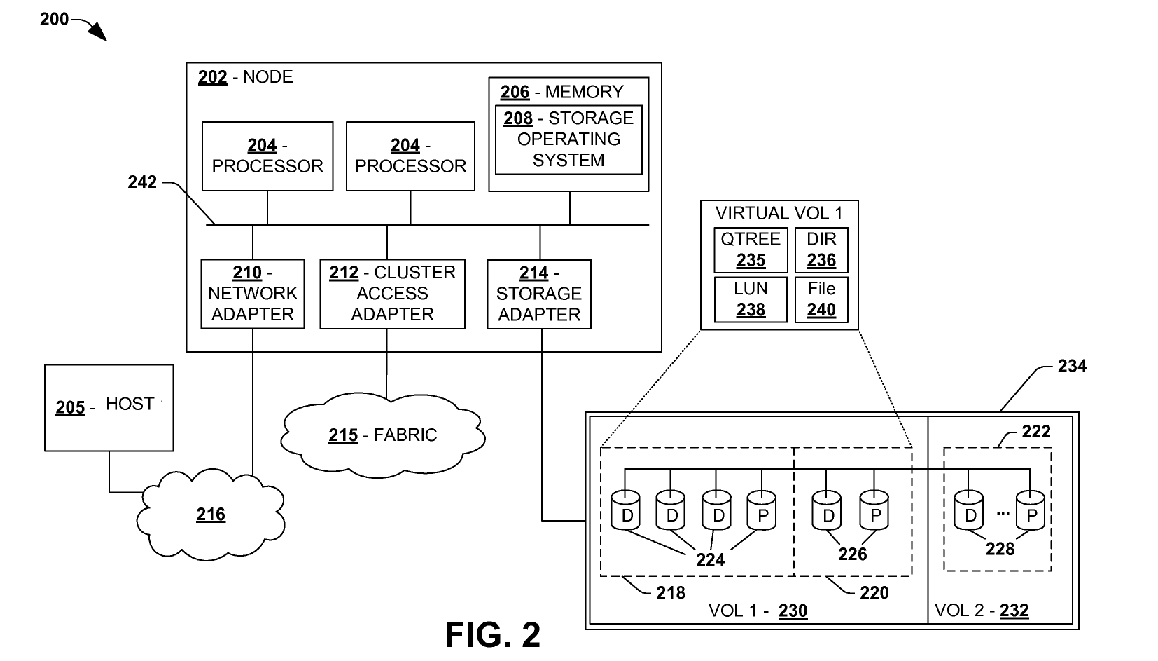

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that facilitating transactions across multiple transactional domains may be implemented for the data storage system 200. For example, a first committer component may be implemented for the node 202 as a first committer associated with a first transactional domain. The first committer component may facilitate transactions between the first transactional domain and other transactional domains of other committers not illustrated.

It may be appreciated that facilitating transactions across multiple transactional domains may be implemented for various types of computing environments and/or devices, such as between servers (e.g., a first bank server and a second bank server), between two computing devices (e.g., a tablet connecting to a media center; a smart phone connecting to a videogame console; a personal computer connecting to a website server; etc.), etc.

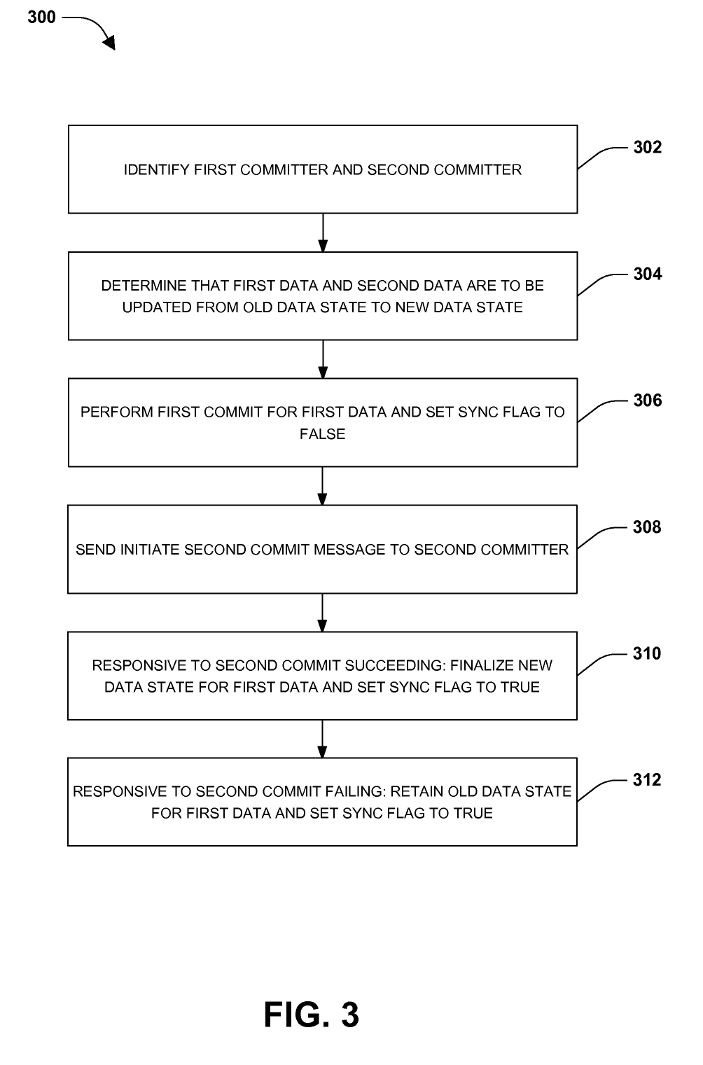

One embodiment of facilitating transactions across multiple transactional domains is illustrated by an exemplary method 300 of FIG. 3. At 302, a first committer that stores first data according to a first transactional domain and a second committer that stores second data according to a second transactional domain may be identified. The first data and the second data may correspond to authentication data (e.g., used to authenticate communication between the first committer and the second committer), communication protocol data (e.g., a negotiation of a protocol, such as an authenticated protocol or an unauthenticated protocol, to use for communication between two devices), and/or any other type of data (e.g., bank account data, multiple versions of a file, etc.). The first transactional domain may be different from the second transactional domain in that the transactional domains may store data differently (e.g., different types of fields for storing data) and/or operate independently (e.g., a failure of the first transactional domain may not imply a failure of the second transactional domain and vice versa).

At 304, a determination may be made that the first data and the second data are to be updated from an old data state to a new data state. In an example, the old data state may correspond to a first authentication key and the new data state may correspond to a second authentication key that may be used for communication between the first committer and the second committer. In an example, the old data state may correspond to a first protocol type (e.g., a first authenticated protocol type or a first unauthenticated protocol type) and the new data state may correspond to a second protocol type (e.g., a second authenticated protocol type or a second unauthenticated protocol type) that may be used for communication between the first committer and the second committer. In an example, a multi-transactional domain policy may be evaluated to determine whether updating from the old data state to the new data state is permissible. The multi-transactional domain policy may specify restrictions on concurrency of updates and/or the types of updates that may be coordinated. For example, the multi-transactional domain policy may specify that a meta-update corresponding to a first transaction to create a first new object in the first transactional domain and a second transaction to create a second new object in the second transactional domain may be permissible. In this way, the multi-transactional domain policy may be used to facilitate multiple updates that may overlap in time.

At 306, a first commit for the first data may be performed within the first transactional domain. The first commit may indicate that a valid state for the second data is allowed to be either the old data state or the new data state, and thus the first committer can accept ambiguity with regard to a current state of the second data. For example, the first committer may commit to the new data state, but may retain the old data state or information used to reconstruct the old data state so that the first committer may proceed using either the old data state (e.g., for facilitating communication using the first authentication key) or the new data state (e.g., for facilitating communication using the second authentication key). A sync flag, used to indicate whether the first committer and the second committer are synchronized (e.g., whether the first committer knows that the current states of the first data and the second data match), may be set to false because the first commit may have committed to updating the first data from the old data state to the new data state and the second committer has not yet performed a corresponding commit to the new data state. The sync flag may be set to false before the first commit, during the first commit (e.g., the sync flag may be set as part of the first commit), or after the first commit.

At 308, responsive to the first commit succeeding, an initiate second commit message may be sent to the second committer to perform a second commit for the second data from the old data state to the new data state.

At 310, responsive to determining that the second commit succeeded (e.g., receiving a commit successful message from the second committer, which may indicate that the second committer is using the new data state for the second data), the new data state may be finalized for the first data, the old data state for the first data may be discarded, and/or the sync flag may be set to true (e.g., because the first committer knows that the first committer and the second committer are both using the new data state). At 312, responsive to determining that the second commit failed (e.g., receiving a commit failure message from the second committer, which may indicate that the second committer is using the old data state for the second data), the new data state may be discarded for the first data, the old data state may be retained for the first data, and/or the sync flag may be set to true (e.g., because the first committer knows that the first committer and the second committer are both using the old data state).

Various techniques may be used to determine whether the second committer updated from the old data state to the new data state (e.g., success of the second commit) or whether the second committer is still utilizing the old data state (e.g., a failure of the second commit). Such techniques may be employed if, for example, there is a loss of transmission of a message, from the second committer to the first committer, which would otherwise have indicated whether the first committer should either finalize the new data state and discard the old data state because the second commit succeeded or retain the old data state and discard the new data state because the second commit failed. In an example of determining whether the second commit succeeded or failed where the old data state corresponds to the first authentication key and the new data state corresponds to the second authentication key, a message may be received from the second committer. Responsive to the sync flag being set to true (e.g., the first committer and the second committer agree on a current state of the data, such as what authentication key to utilize, and the first committer and the second committer operate in accordance with that agreement), a read command may be performed upon the message using the second authentication key corresponding to the new data state. Responsive to the read command succeeding (e.g., successful authentication for the message using the second authentication key), the second commit may be determined as having been successful (e.g., because the message was encrypted using the second authentication key by the second committer). Responsive to the read command failing (e.g., unsuccessful authentication for the message using the second authentication key), the second commit may be determined as having failed (e.g., the message was not encrypted using the second authentication key by the second committer). In this way, transactions across multiple transactional domains may be facilitated for scenarios where both the first committer and the second committer are in agreement on the current state.

Responsive to the sync flag being set to false, a first read command may be performed upon the message using the first authentication key corresponding to the old data state. Responsive to the first read command succeeding (e.g., successful authentication for the message using the first authentication key), the second commit may be determined as having failed (e.g., because the message was encrypted using the first authentication key by the second committer). Responsive to the first read command failing (e.g., unsuccessful authentication for the message using the first authentication key), a second read command may be performed upon the message using the second authentication key. Responsive to the second read command succeeding (e.g., successful authentication for the message using the second authentication key), the second commit may be determined as having been successful (e.g., because the message was encrypted using the second authentication key by the second committer). It will be appreciated that, responsive to the sync flag being set to false, the read commands using the first authentication key and the second authentication key, corresponding to the old data state and the new data state, may be performed in any order. If either read command succeeds, then the success of that read command will determine whether the second commit had been successful or that the second commit had failed.

In another example of determining whether the second commit succeeded or failed where the sync flag is set to false, the first committer may send a message, encrypted based upon the second authentication key, to the second committer. Responsive to receiving a message receipt success notification from the second committer (e.g., the second committer updated the second data from the first authentication key to the second authentication key, and thus successfully authenticated with the message using the second authentication key), the second commit may be determined as having been successful. Responsive to receiving a message rejection notification from the second committer (e.g., the second committer may have unsuccessfully attempted to authenticate with the message using the first authentication key because the second commit failed to update the second data from the first authentication key to the second authentication key), the second commit may be determined as having failed.

In an example, a meta-update transaction may correspond to the creation of a new first object within the first transactional domain and the creation of a new second object within the second transactional domain. The new first object and the new second object may be determined as having a cryptographic relationship. The new first object may be created according to the first transactional domain, such as by the first committer. A cryptographic evaluation may be performed to determine whether a create new second object transaction has been successfully or unsuccessfully committed by the second committer to create the new second object.

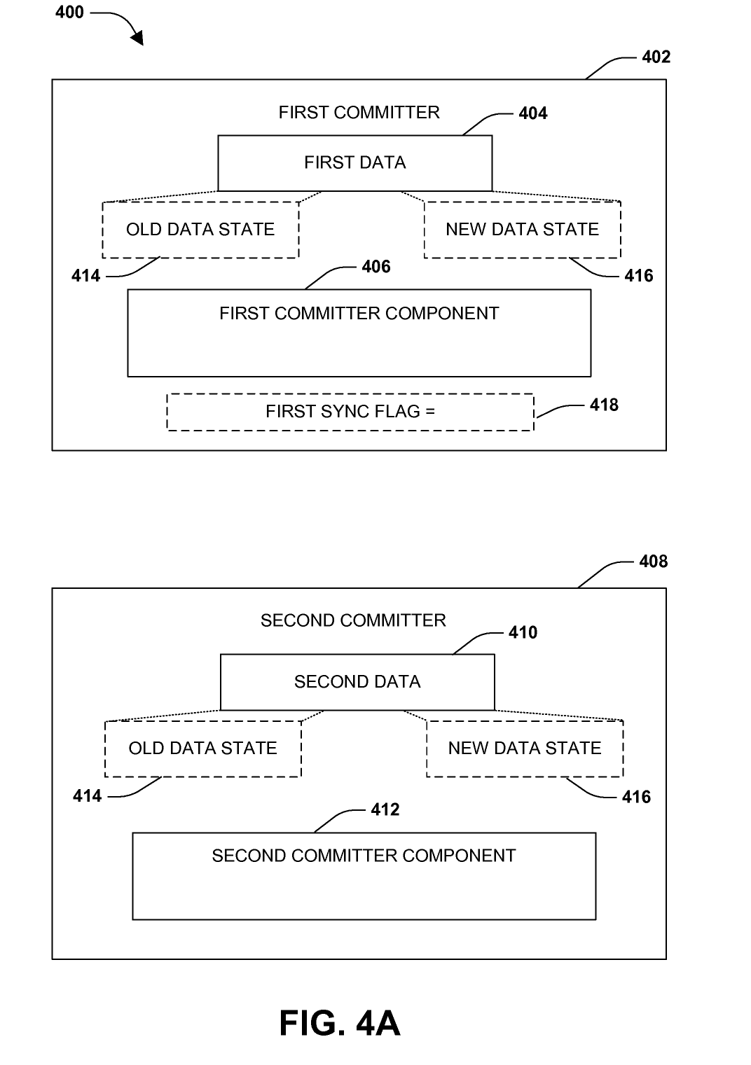

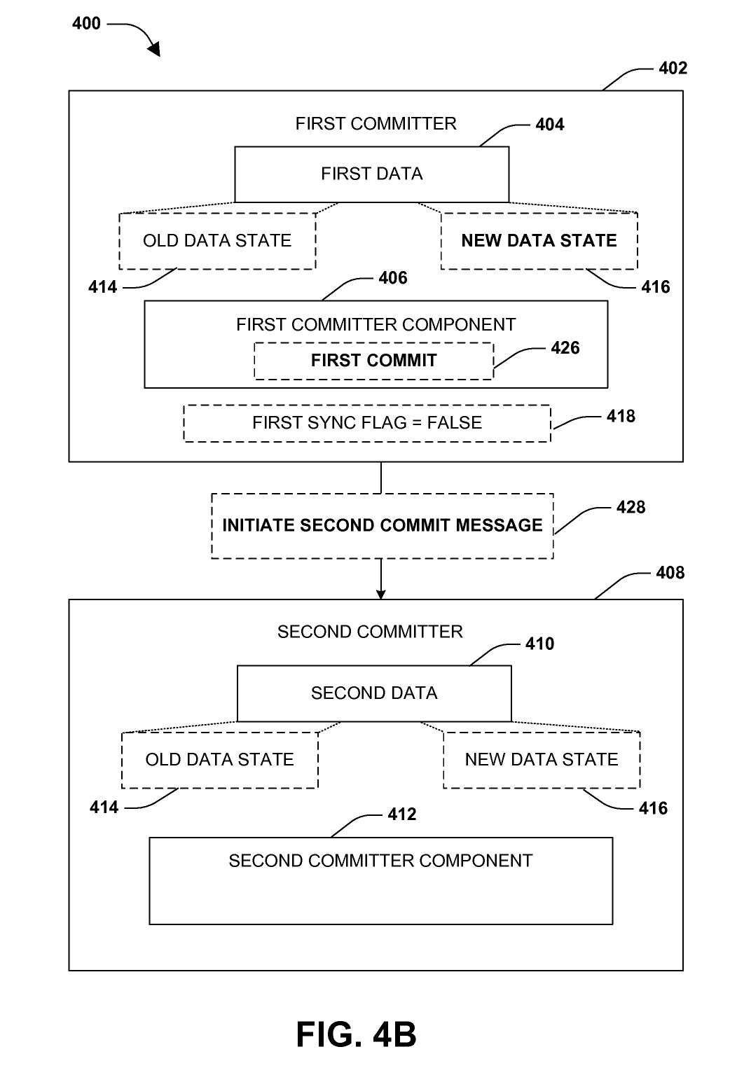

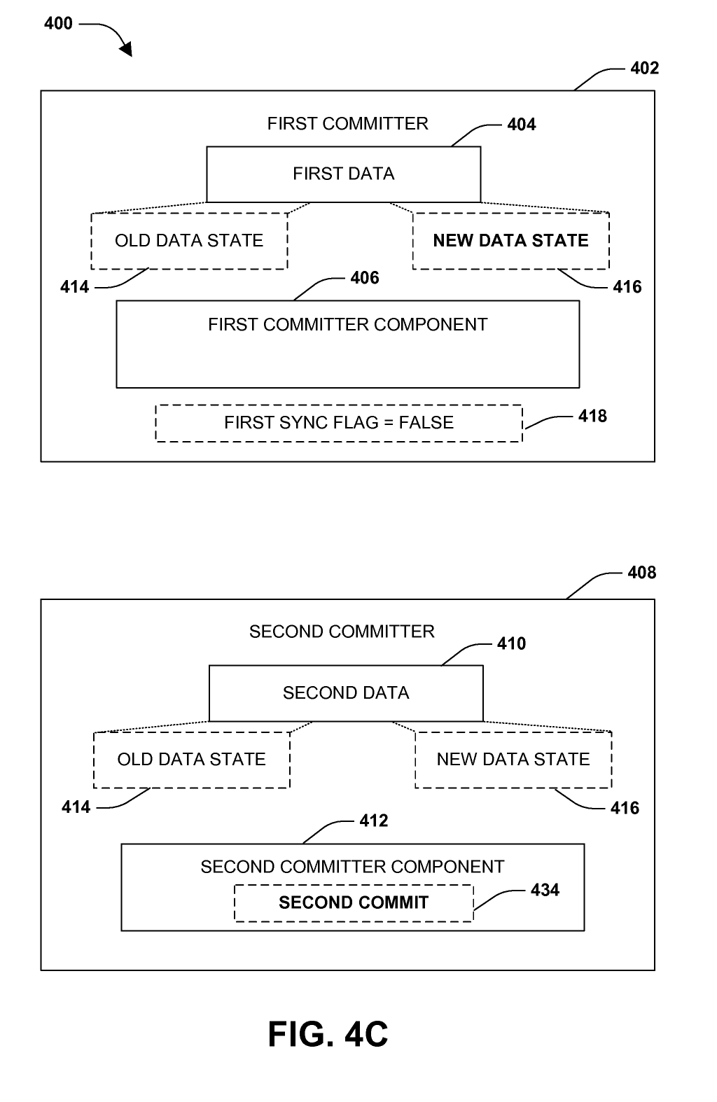

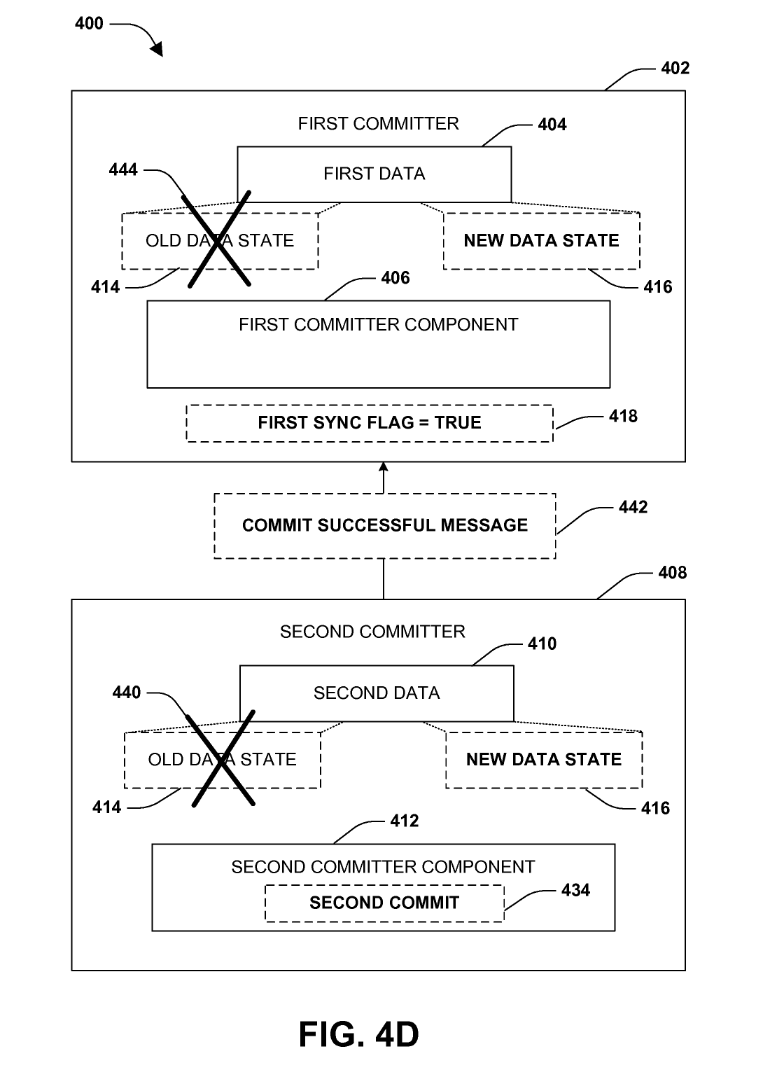

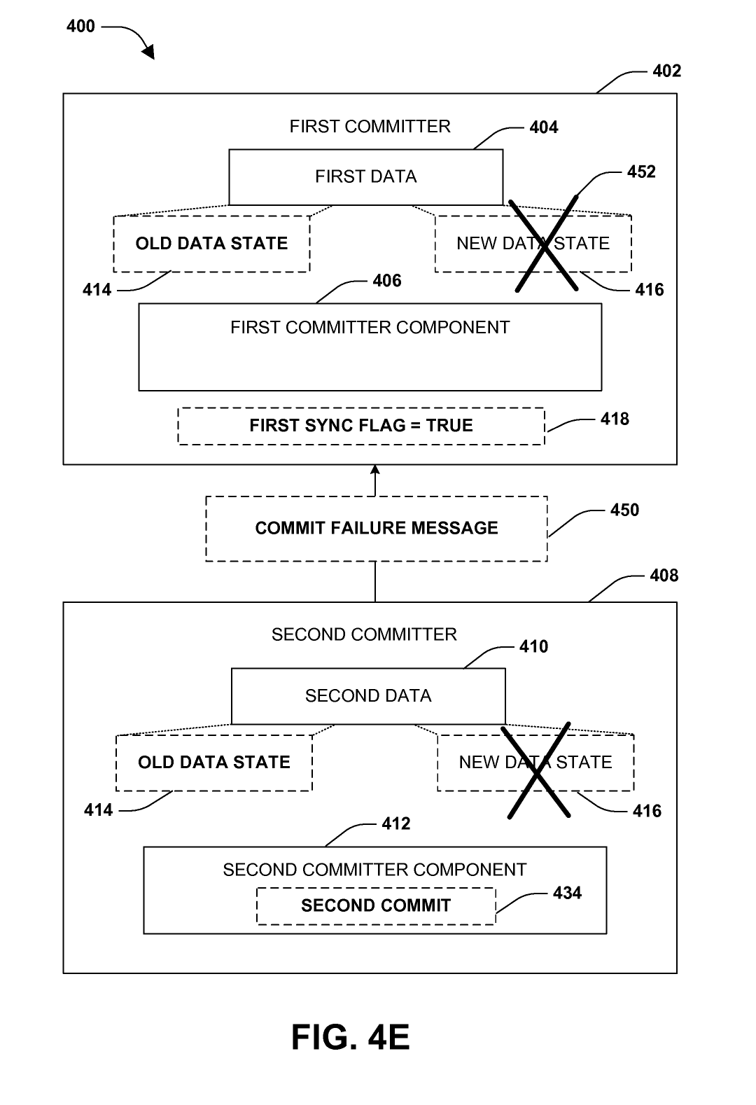

FIGS. 4A-4E illustrate examples of a system 400 for facilitating transactions across multiple transactional domains. In an example, the system 400 comprises a first committer component 406 associated with a first committer 402 that stores first data 404 according to a first transactional domain. In another example, the system 400 comprises a second committer component 412 associated with a second committer 408 that stores second data 410 according to a second transactional domain. FIG. 4A illustrates the first committer component 406 and/or the second committer component 412 determining that the first data 404 and the second data 410 are to be updated from an old data state 414 to a new data state 416 (e.g., the first committer 402, such as a smart phone, and the second committer 408, such as a television, may be negotiating to switch from using a first communication protocol represented by the old data state 414 to a second communication protocol represented by the new data state 416).

FIG. 4B illustrates the first committer component 406 performing a first commit 426 to commit to updating the first data 404 (e.g., communication protocol data) from the old data state 414 to the new data state 416 (e.g., a commitment to use the second communication protocol for communication with the second committer 408). Responsive to the first commit 426 succeeding, the first committer component 406 may set a first sync flag 418 to a false state, thus indicating that current states of the first data 404 and the second data 410 may not match. It will be appreciated that the setting of the first sync flag could be carried out within the first commit, so that the first sync flag may be set to a false state atomically with the agreement to allow the new data state as a possibility. The first committer component 406 may send an initiate second commit message 428 to the second committer 408 (e.g., to the second committer component 412). The initiate second commit message 428 may specify to the second committer 408 that the first committer component 406 committed to the new data state 416 and that the second committer 408 should also commit to the new data state 416.

FIG. 4C illustrates the second committer 408, such as the second committer component 412, attempting a second commit 434. The second commit 434 may be attempted in order to update the second data 410 (e.g., communication protocol data) from the old data state 414 (e.g., the first communication protocol) to the new data state 416 (e.g., the second communication protocol).

FIG. 4D illustrates the first committer component 406 receiving a commit successful message 442 from the second committer 408. The commit successful message 442 may specify that the second commit 434 was successfully performed to update the second data 410 from the old data state 414 to the new data state 416. Thus, the new data state 416 was finalized for the second data 410 and the old data state 414 was discarded for the second data 410 by the second committer 408. Responsive to determining that the second commit 434 succeeded, the first committer component 406 may finalize the new data state 416 for the first data 404, discard 444 the old data state 414 for the first data 404, and/or set the first sync flag 418 to true to indicate that the first data 404 and the second data 410 have both successfully updated to the new data state 416 (e.g., so that communication may be facilitated using the second protocol type).

FIG. 4E illustrates the first committer component 406 receiving a commit failure message 450 from the second committer 408. The commit failure message 450 may specify that the second commit 434 failed, and thus the second committer 408 has maintained the second data 410 according to the old data state 414 and not the new data state 416 (e.g., the second committer 408 may expect to communicate using the first communication protocol). Responsive to determining that the second commit 434 failed, the first committer component 406 may discard 452 the new data state 416 for the first data 404, retain the old data state 414 for the first data 404, and/or set the first sync flag 418 to true to indicate that both the first committer 402 and the second committer 408 are going to use the old data state 414 (e.g., communicate using the first communication protocol).

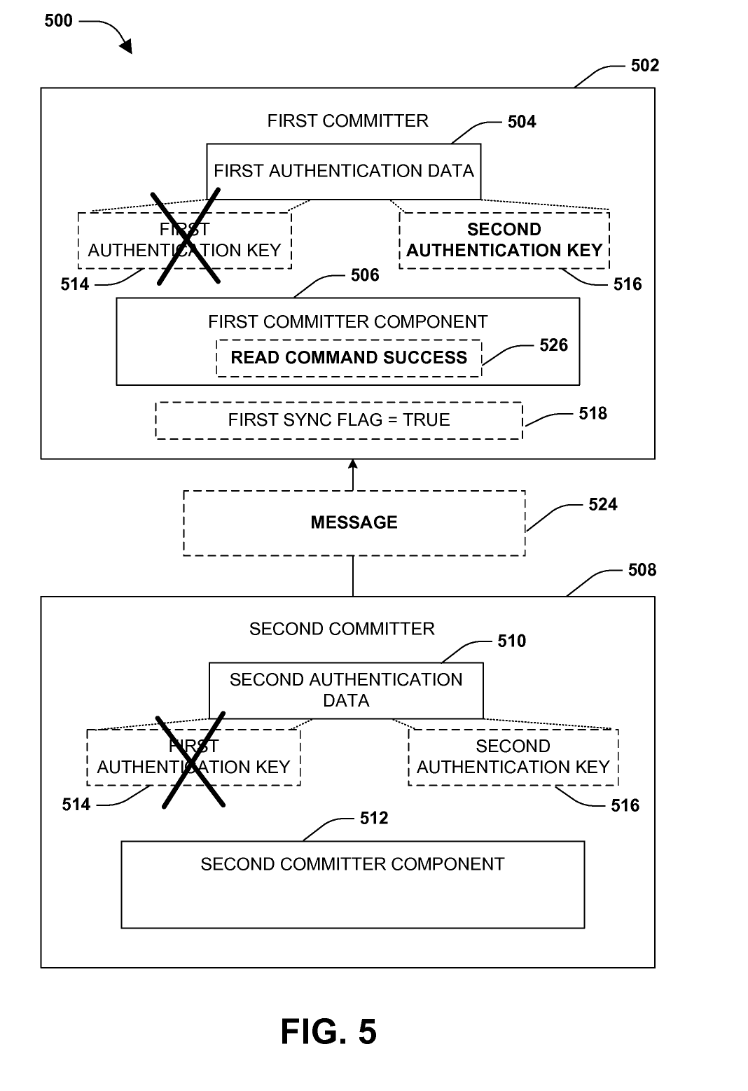

FIG. 5 illustrates an example of a system 500 for facilitating transactions across multiple transactional domains. In an example, the system 500 comprises a first committer component 506 associated with a first committer 502 that stores first authentication data 504 according to a first transactional domain. In another example, the system 500 comprises a second committer component 512 associated with a second committer 508 that stores second authentication data 510 according to a second transactional domain.

The first committer component 506 may have performed a first commit to update the first authentication data 504 from a first authentication key 514 to a second authentication key 516. The first committer component 506 may have sent an initiate second commit message to the second committer 508 to perform a second commit to update the second authentication data 510 from the first authentication key 514 to the second authentication key 516.

The first committer component 506 may evaluate a message 524 from the second committer 508. For example, responsive to a first sync flag 518 being set to true, the first committer component 506 may perform a read command upon the message 524 using the second authentication key 516. Responsive to the read command succeeding 526, the first committer component 506 may determine that the second commit may have been successfully performed by the second committer 508 to update the second authentication data 510 from the first authentication key 514 to the second authentication key 516 because the second authentication key 516 was used to successfully read the message 524 by the first committer component 506. The first committer component 506 may finalize the second authentication key 516 for the first authentication data 504 and/or discard the first authentication key 514 for the first authentication data 504.

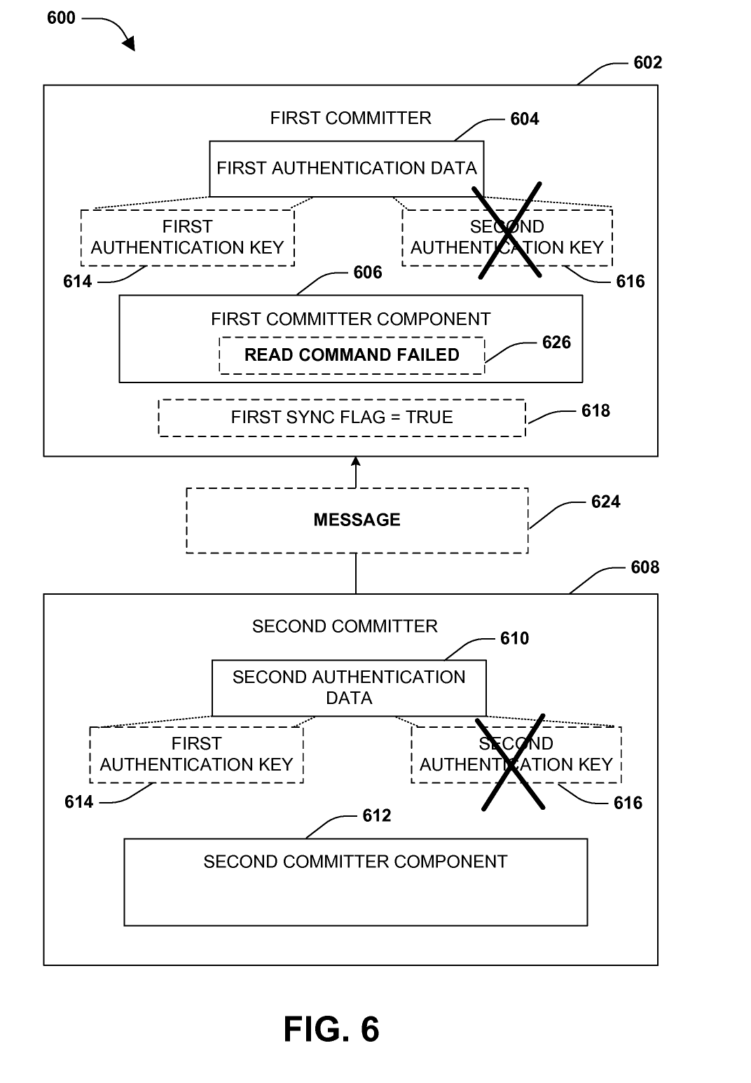

FIG. 6 illustrates an example of a system 600 for facilitating transactions across multiple transactional domains. In an example, the system 600 comprises a first committer component 606 associated with a first committer 602 that stores first authentication data 604 according to a first transactional domain. In another example, the system 600 comprises a second committer component 612 associated with a second committer 608 that stores second authentication data 610 according to a second transactional domain.

The first committer component 606 may have performed a first commit to update the first authentication data 604 from a first authentication key 614 to a second authentication key 616. The first committer component 606 may have sent an initiate second commit message to the second committer 608 to perform a second commit to update the second authentication data 610 from the first authentication key 614 to the second authentication key 616.

The first committer component 606 may evaluate a message 624 from the second committer 608. For example, responsive to a first sync flag 618 being set to true, the first committer component 606 may perform a read command upon the message 624 using the second authentication key 616. Responsive to the read command failing 626 (e.g., the first committer 602 is unable to read the message 624 because the second authentication key 616 was not used by the second committer 608 for creating the message 624), the first committer component 606 may determine that the second committer 608 is not using the second authentication key 616 (e.g., the second commit failed; the second committer 608 has decided to use a different authentication key such as the first authentication key 614 or another authentication key not illustrated; etc.). The first committer component 606 may change the first sync flag 618 from true to false to indicate that current states of the first authentication data 604 and the second authentication data 610 do not match.

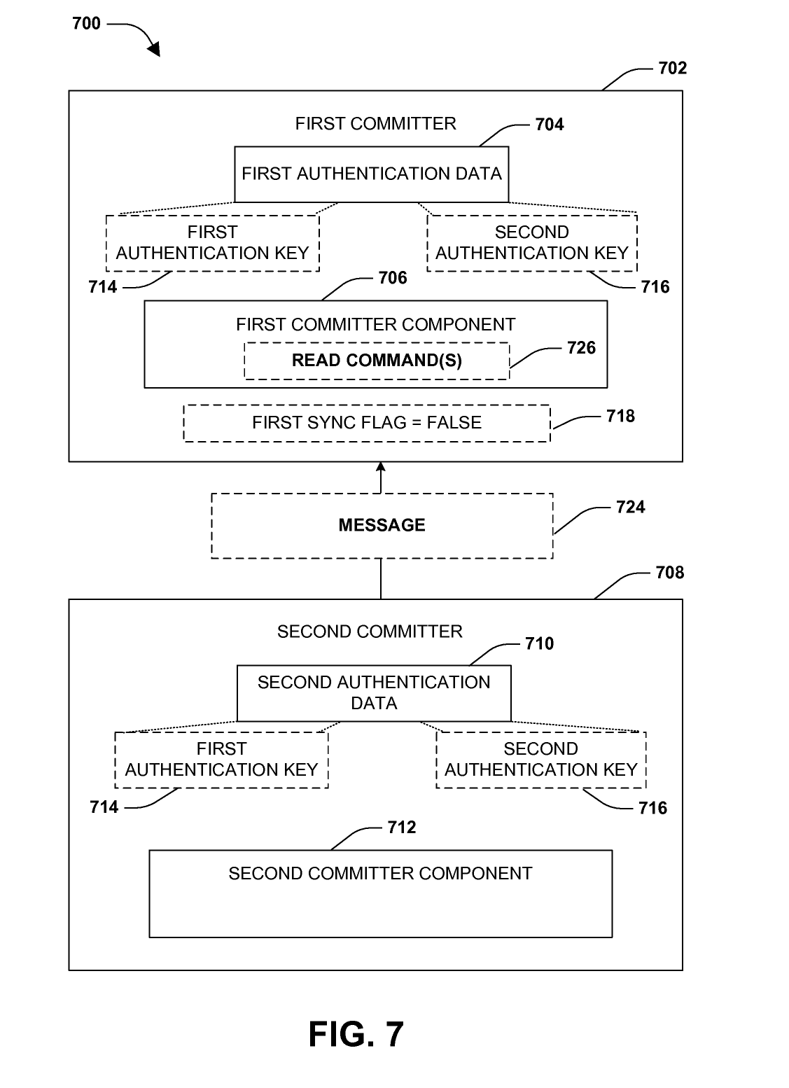

FIG. 7 illustrates an example of a system 700 for facilitating transactions across multiple transactional domains. In an example, the system 700 comprises a first committer component 706 associated with a first committer 702 that stores first authentication data 704 according to a first transactional domain. In another example, the system 700 comprises a second committer component 712 associated with a second committer 708 that stores second authentication data 710 according to a second transactional domain.

The first committer component 706 may have performed a first commit to update the first authentication data 704 from a first authentication key 714 to a second authentication key 716. The first committer component 706 may have sent an initiate second commit message to the second committer 708 to perform a second commit to update the second authentication data 710 from the first authentication key 714 to the second authentication key 716.

The first committer component 706 may evaluate a message 724 from the second committer 708. For example, responsive to a first sync flag 718 being set to false, the first committer component 706 may perform one or more read commands 726 upon the message 724 to determine whether the second commit succeeded or failed. In an example, a first read command may be performed upon the message 724 using the first authentication key 714. Responsive to the read command succeeding, the second commit may be determined as having failed (e.g., the second committer 708 may have sent the message 724 based upon the first authentication key 714). Responsive to determining that the second commit failed, the first committer component 706 may discard the second authentication key 716 for the first authentication data 704, retain the first authentication key 714 for the first authentication data 704, and/or set the first sync flag 718 to true to indicate that both the first committer 702 and the second committer 708 are going to use the first authentication key 714. Responsive to the first read command failing, a second read command may be performed upon the message 724 using the second authentication key 716. Responsive to the second read command succeeding, the second commit may be determined as having succeeded. The first committer component 706 may finalize the second authentication key 716 for the first authentication data 704, discard the first authentication key 714 for the first authentication data 704, and/or set the first sync flag 718 to true to indicate that both the first committer 702 and the second committer 708 are going to use the second authentication key 716. It may be appreciated that the read commands described herein, such as a “first” read command and “second” read command, may be carried out in any order.

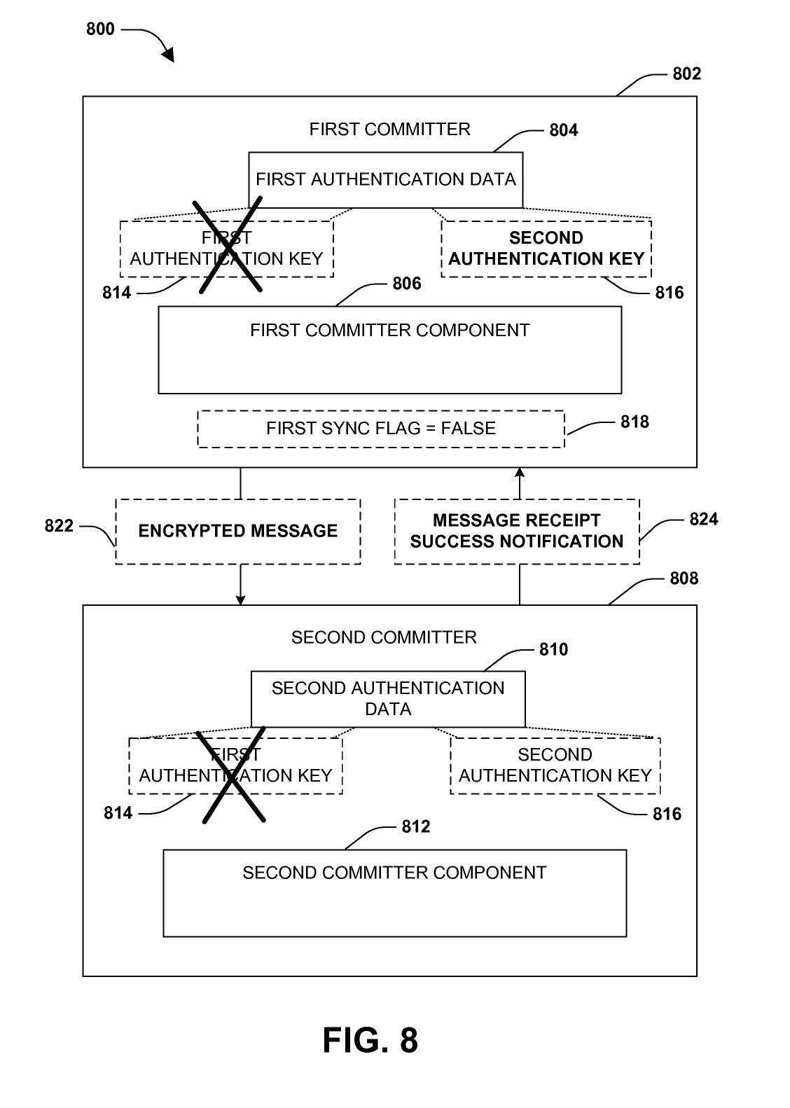

FIG. 8 illustrates an example of a system 800 for facilitating transactions across multiple transactional domains. In an example, the system 800 comprises a first committer component 806 associated with a first committer 802 that stores first authentication data 804 according to a first transactional domain. In another example, the system 800 comprises a second committer component 812 associated with a second committer 808 that stores second authentication data 810 according to a second transactional domain.

The first committer component 806 may have performed a first commit to update the first authentication data 804 from a first authentication key 814 to a second authentication key 816. The first committer component 806 may have sent an initiate second commit message to the second committer 808 to perform a second commit to update the second authentication data 810 from the first authentication key 814 to the second authentication key 816.

Responsive to a first sync flag 818 being set to false, the first committer component 806 may send a message 822, encrypted using the second authentication key 816, to the second committer 808 in order to determine whether the second commit succeeded or failed. Responsive to receiving a message receipt success notification 824 indicating that the second committer 808 successfully accessed the message 822 utilizing the second authentication key 816, the first committer component 806 may determine that the second commit succeeded. The first committer component 806 may finalize the second authentication key 816 for the first authentication data 804, discard the first authentication key 814 for the first authentication data 804, and/or set the first sync flag 818 to true to indicate that both the first committer 802 and the second committer 808 are going to use the second authentication key 816.

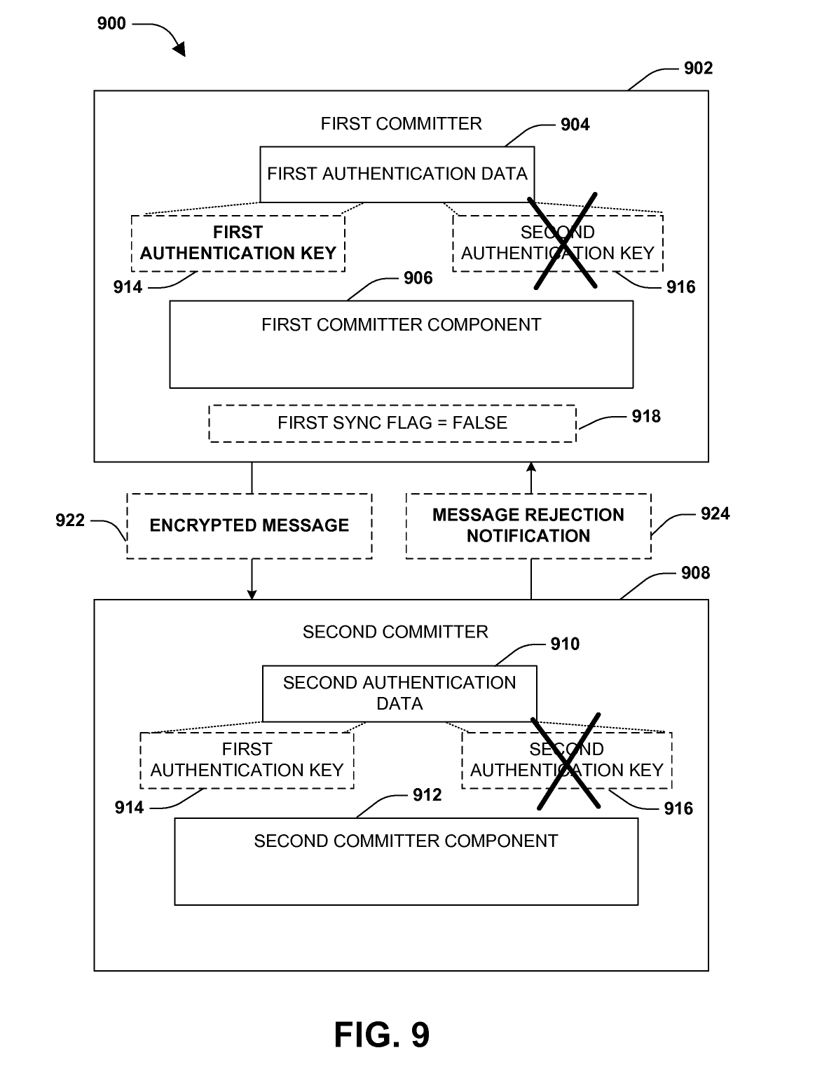

FIG. 9 illustrates an example of a system 900 for facilitating transactions across multiple transactional domains. In an example, the system 900 comprises a first committer component 906 associated with a first committer 902 that stores first authentication data 904 according to a first transactional domain. In another example, the system 900 comprises a second committer component 912 associated with a second committer 908 that stores second authentication data 910 according to a second transactional domain.

The first committer component 906 may have performed a first commit to update the first authentication data 904 from a first authentication key 914 to a second authentication key 916. The first committer component 906 may have sent an initiate second commit message to the second committer 908 to perform a second commit to update the second authentication data 910 from the first authentication key 914 to the second authentication key 916.

Responsive to a first sync flag 918 being set to false, the first committer component 906 may send a message 922, encrypted using the second authentication key 916, to the second committer 908 in order to determine whether the second commit succeeded or failed. Responsive to receiving a message rejection notification 924 indicating that the second committer 908 was unable to access the message 922 (e.g., because the second committer 908 did not successfully update the second authentication data 910 to the second authentication key 916), the first committer component 906 may determine that the second authentication data 910 does not correspond to the second authentication key 916 (e.g., the second commit failed). Responsive to determining that the second commit failed, the first committer component 906 may discard the second authentication key 916 for the first authentication data 904.

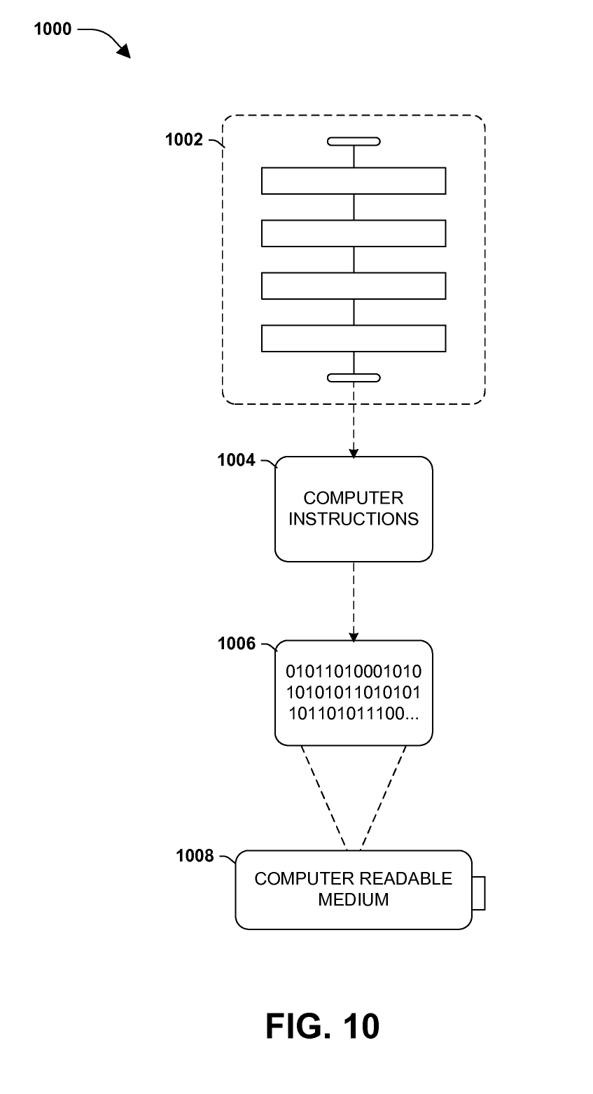

Still another embodiment involves a computer-readable medium comprising processor-executable instructions configured to implement one or more of the techniques presented herein. An example embodiment of a computer-readable medium or a computer-readable device that is devised in these ways is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 300 of FIG. 3, for example. In some embodiments, the processor-executable instructions 1004 are configured to implement a system, such as at least some of the exemplary system 400 of FIGS. 4A-4E, at least some of the exemplary system 500 of FIG. 5, at least some of the exemplary system 600 of FIG. 6, at least some of the exemplary system 700 of FIG. 7, at least some of the exemplary system 800 of FIG. 8, and/or at least some of the exemplary system 900 of FIG. 9, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for facilitating transactions across multiple transactional domains, comprising:
a processor; and
a memory containing instructions which when executed by the processor implement at least some of:
a first committer component associated with a first committer that stores first data according to a first transactional domain, the first committer component configured to:
identify a second committer that stores second data according to a second transactional domain;
determine that the first data and the second data are to be updated from an old data state to a new data state;
perform a first commit for the first data, the first commit indicating that a valid state of the second data is allowed to be either the old data state or the new data state, a sync flag is set to false based upon the first commit;
responsive to the first commit succeeding, send an initiate second commit message to the second committer to perform a second commit for the second data from the old data state to the new data state;
responsive to determining that the second commit succeeded:
finalize the new data state for the first data;
discard the old data state for the first data; and
set the sync flag to true; and
responsive to determining that the second commit failed:
discard the new data state for the first data;
retain the old data state for the first data; and
set the sync flag to true.

2. The system of claim 1, the first data and the second data corresponding to authentication data.

3. The system of claim 2, the old data state corresponding to a first authentication key and the new data state corresponding to a second authentication key.

4. The system of claim 1, the first committer component configured to:
determine that the second commit succeeded based upon receiving a commit successful message from the second committer.

5. The system of claim 1, the first committer component configured to:
determine that the second commit failed based upon receiving a commit failure message from the second committer.

6. The system of claim 1, the first data corresponding to a first cryptographic key and the second data corresponding to a second cryptographic key.

7. The system of claim 3, the first committer component configured to:
receive a message from the second committer;
responsive to the sync flag being set to false, perform a read command upon the message using the first authentication key; and
responsive to the read command succeeding, determine that the second commit failed.

8. The system of claim 3, the first committer component configured to:
responsive to a read command of a message from the second committer failing:
perform a second read command upon the message using the second authentication key; and
responsive to the second read command succeeding, determine that the second commit succeeded.

9. The system of claim 3, the first committer component configured to:
responsive to the sync flag being set to false:
send a message, encrypted based upon the second authentication key, to the second committer; and
responsive to receiving a message receipt success notification from the second committer, determine that the second commit succeeded.

10. The system of claim 3, the first committer component configured to:
responsive to the sync flag being set to false:
send a message, encrypted based upon the first authentication key, to the second committer; and
responsive to receiving a message rejection notification from the second committer, determine that the second commit failed.

11. The system of claim 1, the first data and the second data corresponding to communication protocol data.

12. The system of claim 11, the old data state corresponding to a first protocol type and the new data state corresponding to a second protocol type.

13. The system of claim 11, the old data state corresponding to an unauthenticated protocol type and the new data state corresponding to an authenticated protocol type.

14. The system of claim 1, the first committer component configured to:
create a new first object according to the first transactional domain;
determine that a new second object is to be created by the second committer according to the second transactional domain, the new first object and the new second object having a cryptographic relationship; and
perform a cryptographic evaluation to determine whether a create new second object transaction has been successfully committed by the second committer to create the new second object or has failed.

15. The system of claim 1, the first committer component configured to:
evaluate a multi-transactional domain policy to determine whether updating from the old data state to the new data state is permissible.

16. The system of claim 1, the first transactional domain corresponding to at least one of a first field or a first command and the second transactional domain not corresponding to at least one of the first field or the first command.

17. A method for facilitating transactions across multiple transactional domains, comprising:
identifying a first committer that stores first data according to a first transactional domain and a second committer that stores second data according to a second transactional domain;
determining that the first data and the second data are to be updated from an old data state to a new data state;
performing a first commit for the first data, the first commit indicating that a valid state of the second data is allowed to be either the old data state or the new data state, a sync flag is set to false based upon the first commit;
responsive to the first commit succeeding, sending an initiate second commit message to the second committer to perform a second commit for the second data from the old data state to the new data state;
responsive to determining that the second commit succeeded:
finalizing the new data state for the first data;
discarding the old data state for the first data; and
setting the sync flag to true; and
responsive to determining that the second commit failed:
discarding the new data state for the first data;
retaining the old data state for the first data; and
setting the sync flag to true.

18. The method of claim 17, the first data and the second data corresponding to authentication data, the old data state corresponding to a first authentication key and the new data state corresponding to a second authentication key, and the method comprising:
receiving a message from the second committer;
responsive to the sync flag being set to false, performing a read command upon the message using the second authentication key; and
responsive to the read command succeeding, determining that the second commit succeeded.

19. The method of claim 17, the first data and the second data corresponding to authentication data, the old data state corresponding to a first authentication key and the new data state corresponding to a second authentication key, and the method comprising:
receiving a message from the second committer;
responsive to the sync flag being set to false, performing a read command upon the message using the first authentication key;
responsive to the read command succeeding, determining that the second commit failed; and
responsive to the read command failing:
performing a second read command upon the message using the second authentication key; and
responsive to the second read command succeeding, determining that the second commit succeeded.

20. A computer readable medium comprising instructions which when executed perform a method for facilitating transactions across multiple transactional domains, comprising:
identifying a first committer that stores first data according to a first transactional domain and a second committer that stores second data according to a second transactional domain;
determining that the first data and the second data are to be updated from an old data state to a new data state;
performing a first commit for the first data, the first commit indicating that a valid state of the second data is allowed to be either the old data state or the new data state, a sync flag is set to false based upon the first commit;
responsive to the first commit succeeding, sending an initiate second commit message to the second committer to perform a second commit for the second data from the old data state to the new data state;
responsive to determining that the second commit succeeded:
finalizing the new data state for the first data;
discarding the old data state for the first data; and
setting the sync flag to true; and
responsive to determining that the second commit failed:
discarding the new data state for the first data;
retaining the old data state for the first data; and
setting the sync flag to true.
